(19) United States
(12) Patent Application Publication
(10) Pub. No.: US 2009/0280897 A1
(43) Pub. Date: Nov. 12, 2009

(54) Method and Apparatus for Producing Interactive Video Content

(76) Inventors: Simon Fitzmaurice, Greystones (IE); Chris Carlile, Bray (IE)

Correspondence Address: K&L Gates LLP, STATE STREET FINANCIAL CENTER, One Lincoln Street, BOSTON, MA, 02111-2950, US

(21) Appl. No.: 12/352,680

(22) Filed: Jan. 13, 2009

Related U.S. Application Data
(60) Provisional application No. 61/020,861, filed on Jan. 14, 2008.

(51) Int. Cl. A63F 13/00; H04N 5/228; G11B 27/00

(52) U.S. Cl. 463/30; 348/222.1; 386/52

(57) ABSTRACT

A method and apparatus for generating interactive video content. In one embodiment, the method includes the steps of providing a first video content; providing a set of directions on a monitor in response to the first video content; video capturing a user-actor following the directions; embedding the captured video in the first video content to form a combined video content; and displaying the combined content. In one embodiment, the system includes a first video scene content; a video monitor providing acting instructions and dialog in response to the first video scene content; video capture means for video capturing a game player following the acting instructions and performing the dialog; video editing means for embedding the captured video in the first video content to form a combined video content; and a display for displaying the combined video content.

### RELATED APPLICATIONS

This application claims priority to provisional application No. 61/020,861 filed on Jan. 14, 2008, the contents of which are incorporated herein by reference.

### FIELD OF THE INVENTION

The present invention relates generally to a method and apparatus for producing interactive video content and more specifically for capturing and displaying actions by a user/actor along with motion video scenes.

### SUMMARY OF THE INVENTION

In one aspect, the invention relates to a method for generating interactive video content. In one embodiment, the method includes the steps of providing a first video content; providing a set of directions on a monitor in response to the first video content; video capturing a user-actor following the directions; embedding the captured video in the first video content to form a combined video content; and displaying the combined content.

In another aspect, the invention relates to playing an interactive videogame. In one embodiment, the method includes the steps of: providing a first video scene content; providing acting instructions and dialog in response to the first video scene content on a video monitor; video capturing a game player (a user or actor or user/actor) following the acting instructions and performing the dialog; embedding the captured video in the first video content to form a combined video content; and displaying the combined video content. In another embodiment, the first video content is a movie scene. In another embodiment, the acting instructions and dialog are from the movie scene and the game player acts the part of a character in the scene. In still yet another embodiment, the movie scene is from a movie specially made for this application. In another embodiment, the embedded captured video replaces an original character in a scene in a standard release movie.

In another aspect, the invention relates to a system for playing an interactive videogame. In one embodiment, the system includes a first video scene content; a video monitor providing acting instructions and dialog in response to the first video scene content; video capture means for video capturing a game player following the acting instructions and performing the dialog; video editing means for embedding the captured video in the first video content to form a combined video content; and a display for displaying the combined video content.

### BRIEF DESCRIPTION OF THE DRAWINGS

These embodiments and other aspects of this invention will be readily apparent from the description below and the appended drawings, which are meant to illustrate and not to limit the invention, and in which:

FIG. 1 is a block diagram illustrating a system for according to an embodiment of the present invention;

FIG. 2 is a flow diagram of an embodiment of the steps of the method implemented with the embodiment of the invention in FIG. 1; and

FIG. 3 is an example of a video screen as seem by a user-actor of the system of FIG. 1.

### DESCRIPTION

The present invention will be more completely understood through the following description, which should be read in conjunction with the attached drawings. In this description, like numbers refer to similar elements within various embodiments of the present invention. Within this description, the claimed invention will be explained with respect to embodiments. However, the skilled artisan will readily appreciate that the methods and systems described herein are merely exemplary and that variations can be made without departing from the spirit and scope of the invention.

In brief overview, the invention utilizes motion image capture to impose a video image of a user/actor into a motion video scene. The system provides dialog and director instruction such that the user/actor can act a part in a video production. The system is constructed so as to replace a character or characters in the scene with the user/actor such that the user/actor blends with the scene. For example the motion video scene could be one from “Casablanca” and a user/actor could take the place of Bogart speaking to Bergman. The system would provide stage directions and a scrolled dialog. The user/actor reading the dialog and following the directions in the script would be recorded against a green screen and the recorded image superimposed over the Bogart character in the scene. The system would also record the voice of the user/actor and place it modified or unmodified in the sound track of the scene. The background video upon which the user/actor is imposed can either be from a released movie (e.g. Casablanca) or can be specially produced for this system.

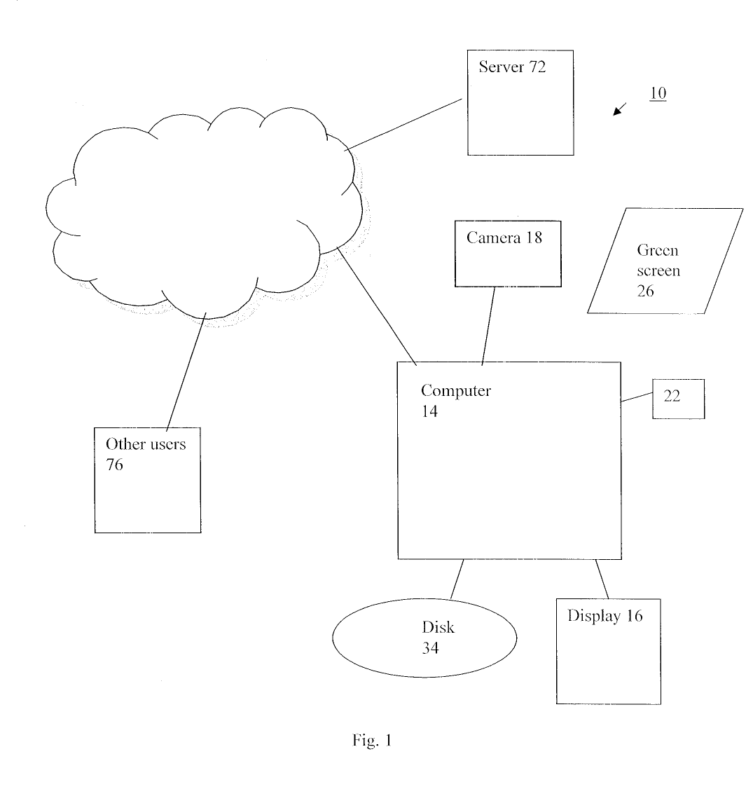

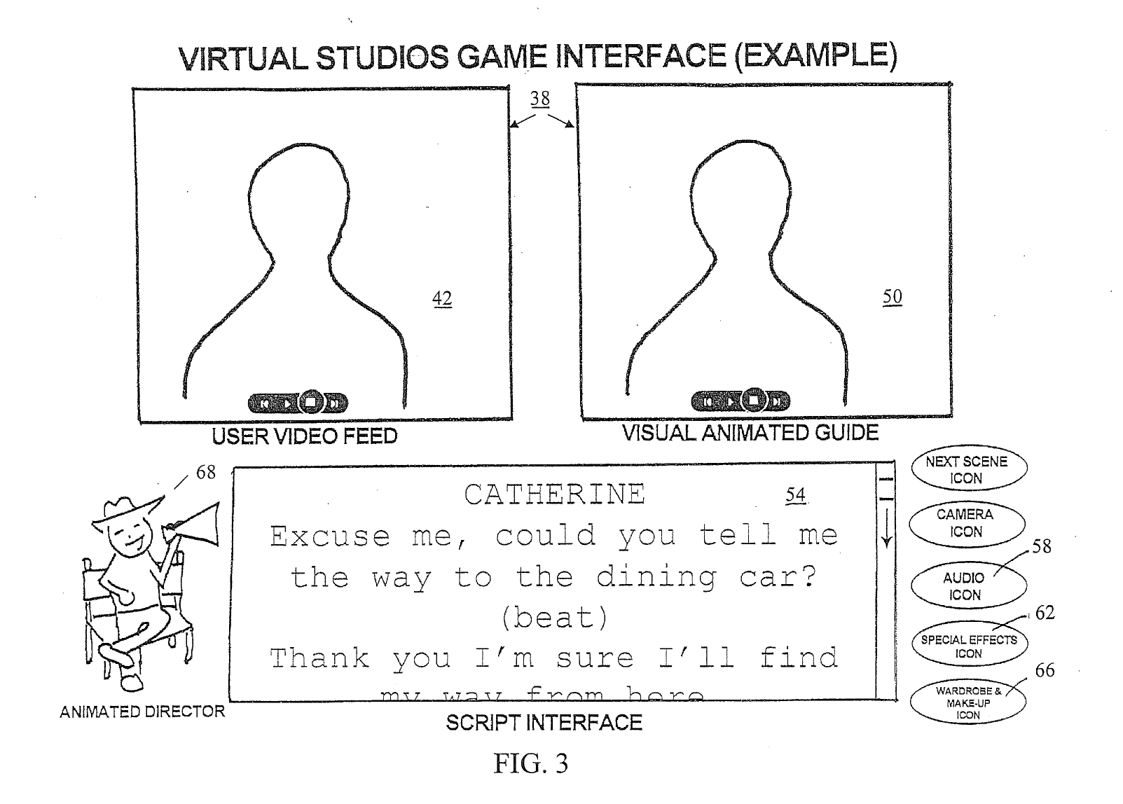

In general, and referring to FIG. 1, the system 10 includes a computer 14 to which is connected a display 16, a camera 18 and a microphone 22. The camera 18 is pointed toward a green screen 26, in front of which the user/actor-actor sits. The computer 14 executes the content program 30, and the camera 18 and microphone 22 captures to disk 34 the images and the voice, respectively, of the user/actor. The computer display 16 provides a user interface. In one embodiment (FIG. 3) the user interface is a graphical user interface or GUI that includes two windows 38; one 42 with the user/actor's video as captured by the camera 18 and the other 46 with an animated FIG. 50 displaying the ideal action to be performed.

As the program is executed by the computer 14, the script appears in teleprompt mode, scrolling 54 along the bottom of the display screen. The speed of the scrolling can be set and reset according to the user/actor's desires. Additionally the user/actor can adjust using an audio icon 58 their recorded voice characteristics to suit the character: e.g. the pitch of a male voice may be adjusted to sound female etc. The user/actor can also choose from a range of special effects (special effects icon 62) within the scene. For example, in a car chase the user/actor can choose whether the car goes under the truck or over it. The selection by the user/actor is then used to select which predetermined sequence is to appear on the screen.

The system 10 also guides the user/actor as to the ideal costume, hair and make-up requirements for each scene (wardrobe & makeup icon 66). For example the system might inform the user/actor that “gelling” the hair produces an optimum green screen capture effect. Additionally the user/actor may select from a range of virtual costume, hair and make-up options.

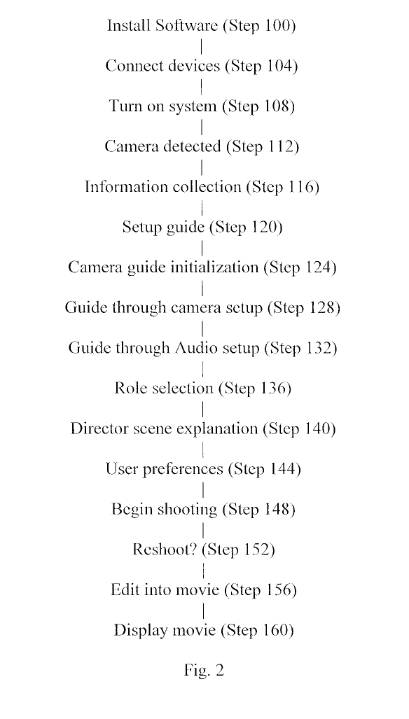

Exemplary steps in using an embodiment of the present invention are shown in FIG. 2. In Step 100, the use installs the software onto his or her local computer, and (Step 104) connects the capture device, such as a CCD camera to the computer. When the system is turned on, (Step 108) an Animated Agent, shown in one embodiment with cigar, sitting behind wide desk appears and says “So you want to be a star? But have you got what it takes?”. In Step 112 a camera icon and a green screen icon appear on screen and the computer indicates on the screen that it detects the camera.

In the next step (Step 116), information about the User is collected, so that he or she can be addressed by name. In one embodiment the Animated Agent provides a “contract” for the user/actor to “execute. The Animated Agent says “You do? Okay, you wanna be with me? Sign this.” The monitor shows a “contract” and the user/actor fills in all required personal details. At this point the Animated Agent says “Now get out of here! Go talk to Conrad.” and blows smoke into the camera. At this point an Animated Camera Wizard guides user/actor through set-up of camera and green screen. (Step 120)

On the monitor, the scene shifts (Step 124) to “Conrad, cinematographer” and Animated Camera Guide. Conrad is tidily dressed and well spoken. “Hi I'm Conrad. Nice to meet you. Ooh, you look good in this light. Let's get you set up and see how you look” The Animated Camera Guide then guides (Step 128) user/actor through game interface; bringing the user/actor through the process of setting up camera, green screen and lighting. In Step 132, an Animated Sound Wizard (“Jeremy, the Sound Guy”) guides user/actor through sound set-up by doing a sound check.

At this point the system is read to use. In the next step (Step 136) the Casting Session, the user/actor or users/actors (if there are more than one) select their respective role(s) in game. To do this the user/actor or user/actors go to the Casting Session, and meet the Casting Agent. The user/actor chooses number of actors and the roles to play.

In Step 140, a user/actor meets the Director who will lead the user/actor through the video capture process. That is, the Director explains the first scene and what he wants from the user/actor, ending with “You've read the script. You are perfect for this part. Let's do it.” The Director shrinks in size and takes his seat 68 (FIG. 3) at the bottom left-hand corner of the screen. This character icon acts as a software ‘wizard’ in that he will be the animated guide to the video capture process. This is repeated for each user/actor.

Each user/actor makes (Step 144) the selections he or she desires regarding voice characteristics, scroll speed etc. using the GUI interface and then the shooting (Step 148) of the video begins when the user/actor presses the action button. The video display shows the clapper board; the director shouts ‘Action’ and the user/actor's performance are recorded.

The user/actor has the option to playback the scene and re-shoots the scene (Step 152). During the re-shoot, the Director gives direction, feedback and encouragement. When the user/actor is satisfied with the result the next portion of the process occurs. Thus each user/actor matches the action and speech requirements of each scene; recording them and moving on to the next user/actor or scene.

It must be noted that each scene represents only a part of the whole of the final film. The user/actor is not (and need not) be aware of the context of each his/her scene and the full scene is not revealed until the final version of the film is “cut”. For example, this fragmentation includes dialogue. That is, the user/actor may have to fulfill one side of a conversation which will only make sense when the final film is put together. This maintains expectation and mystery throughout the performance/game.

When all the users/actors complete their respective scenes, a user/actor presses the ‘Create Movie’ button and post-production process begins. The program edits (Step 156) all scenes into the final movie. Each scene is ‘auto-fitted’ and ‘auto-graded’ by the program on the computer.

In another embodiment the scenes may be uploaded to a server 72 (FIG. 1) which edits the movie and sends it back to the user/actor. This means the user's/actor's computer does not require the post-production editing capability. In this embodiment multi-player roles may be completed in different locations, e.g. a Christmas family movie may star family members each located in different locations around the world. Each family member 76 (FIG. 1) would complete their scenes on their own computers and upload them to the server 72 for completion. Similarly, unrelated users/actors could come together through an online server and uploading their scenes to the server for completion.

The next step (Step 160) is to watch the movie. The program allows the user/actor to watch the movie on the display; burn a DVD of the movie; export the movie to a mobile device (e.g. ipod/cell phone); upload the movie to a server for viewing by the community or email the movie.

The user/actor(s) then watch the world premiere of the film, starring his or herself. In one embodiment a logo precedes the movie, followed by the title sequence which lists the names of the users/actors. In various embodiments the title sequence includes, for example, feature clips from the movie to come, with freeze frames of the characters as their names appear.

In other embodiments the program includes an option for an awards ceremony to follow the movie. In this embodiment each user-actor has had to perform an acceptance speech during the production period of the content. In various embodiments the computer randomly selects award-winners or there is an option for each user-actor to vote in a ballot provided by the software.

In one embodiment the display shows a red carpet, paparazzi and the awards. A comedian host introduces clips from the nominated users/actors' performances. The users/actors are seen in split-screen nervously sitting in their seats. The awards are announced and the winning acceptance speech is shown. In one embodiment the users/actors would have had to perform nervousness, happiness and disappointment in the production process not knowing the final outcome.

In yet another embodiment, budding actors and acting groups compete to submit the best version possible of a production as judged by film industry professionals. The prize is a potential cinema release, television broadcast or online broadcast of the film.

In still yet another embodiment, alternative characters, endings, special effects are down loadable to software. Similarly, additional story lines may be downloadable either by subscription or individual purchase.

The invention may be used for a number of purposes besides acting entertainment. These include: Business productions—e.g. users/actors engage in interview/speech making techniques; Sports Events—e.g. users/actors play in St. Andrews against Tiger Woods, race in Grand Prix, play at Wimbledon, Yankee Stadium; Karaoke—users/actors participate in music scenarios, e.g. live concerts, acoustic sessions, music videos; Stand-Up Comedy—users/actors provide the jokes, and the program provides the laughs (and the audience); or Interactive Role Play—users/actors perform in scenes as they progress through the game, e.g. fighting a dragon to get to the gold; walking through a maze; solving a crime (single to multiple player). In addition, relevant items for school curriculum, for example, the play Hamlet, may be used for class participation whereby class members participate directly in the production.

Variations, modification, and other implementations of what is described herein will occur to those of ordinary skill in the art without departing from the spirit and scope of the invention as claimed. Accordingly, the invention is to be defined not by the preceding illustrative description, but instead by the spirit and scope of the following claims.

What is claimed is:

1. A method for generating interactive video content comprising the steps of:
providing a first video content;
providing a set of directions on a monitor in response to the first video content;
video capturing a user-actor following the directions;
embedding the captured video in the first video content to form a combined video content; and
displaying the combined content.

2. A method for playing an interactive videogame comprising the steps of:
providing a first video scene content;
providing acting instructions and dialog in response to the first video scene content on a video monitor;
video capturing a game player following the acting instructions and performing the dialog;
embedding the captured video in the first video content to form a combined video content; and
displaying the combined video content.

3. The method of claim 2 wherein the first video content is a movie scene.

4. The method of claim 3 wherein the acting instructions and dialog are from the movie scene and the game player acts the part of a character in the scene.

5. The method of claim 4 wherein the movie is specially made for this user-actor interaction.

6. The method claim 4 wherein the embedded captured video replaces an original character in the scene.

7. A system for playing an interactive videogame comprising:
a first video scene content;
a video monitor providing acting instructions and dialog in response to the first video scene content;
video capture means for video capturing a game player following the acting instructions and performing the dialog;
video editing means for embedding the captured video in the first video content to form a combined video content; and
a display for displaying the combined video content.
